(19) United States
(12) Patent Application Publication
(10) Pub. No.: US 2017/0004515 A1
(43) Pub. Date: Jan. 5, 2017

(54) TECHNIQUES FOR PROVIDING A RETAIL POLL SERVICE

(71) Applicant: Straw, LLC, Snoqualmie, WA (US)

(72) Inventors: Jason Wilmot, Snoqualmie, WA (US); Craig Kitterman, Snoqualmie, WA (US); Ben Rudolph, Snoqualmie, WA (US); Nate Gunderson, Snoqualmie, WA (US)

(21) Appl. No.: 14/788,284

(22) Filed: Jun. 30, 2015

(51) Int. Cl. G06Q 30/02

(52) U.S. Cl. CPC G06Q 30/0203; G06Q 30/0241

(57) ABSTRACT

Embodiments of the present disclosure describe techniques for facilitating a poll service. In an embodiment, an apparatus for facilitating a poll service may comprise a processor, and a polling platform module operated by the processor to facilitate a poll creation and distribution to a plurality of poll recipients, based on a selection, by a user at a retail entity, of one or more items from a plurality of items provided by the retail entity, and provide poll results, submitted by some of the plurality of poll recipients in response to the poll distribution, to the retail entity, to facilitate targeting of the poll recipients by the retail entity. The poll recipients are external to the retail entity. Other embodiments may be described and/or claimed.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Shoppers are turning to online resources on a more frequent basis to investigate items (e.g., products and/or services) which the shopper (e.g., user of online retail entity or a brick and mortar retail establishment) may be considering purchasing. When browsing products or services, shoppers may look at retail web sites, online review repositories, or similar resources to obtain information concerning the products or services they are contemplating purchasing. Shoppers may search for information about a level of quality of the product or service and if other individuals recommend purchasing the product or service. These resources may use various numerical rating scales that may differ from one resource to another which may make it difficult for shoppers to compare information from one resource with information from another. In addition, shoppers may have to wade through unstructured online reviews to locate information pertinent to an individual shopper's decision making. Furthermore, it may be difficult for shoppers to fully trust reviews from these resources as they may be anonymous and, as a result, the shoppers may need to differentiate between reviews that appear to contain information of a higher quality from reviews that appear to contain information of a lower quality without any reference for the individual that actually left the review other than the content contained therein. In some instances the reviews that purport to be associated with a product or service may be based instead on the users' experience with the retail entity rather than the product or service.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is an example polling system, in accordance with various embodiments of the present disclosure.

FIG. 2 is an example process flow of a polling service of the polling system of FIG. 1, in accordance with various embodiments of the present disclosure.

FIG. 3 is an example process flow of a polling platform provided by a polling server of FIG. 1, in accordance with various embodiments of the present disclosure.

FIG. 4 is an example process flow of a poll completion procedure that may be performed by a computing device associated with a poll recipient, in accordance with various embodiments of the present disclosure.

FIG. 5 is an example computing device suitable for implementing the embodiments of the present disclosure, in accordance with various embodiments of the present disclosure.

FIG. 6 is an example non-transitory computer-readable storage medium with instructions configured to enable a computing device to practice the present disclosure, in accordance with various embodiments of the present disclosure.

FIGS. 7-9 are example views of a polling service web interface, in accordance with some embodiments.

### DETAILED DESCRIPTION

A cloud-based polling system that may be leveraged to solicit feedback on products and/or services an individual is considering purchasing is discussed herein. Whether engaged in an online retail experience or making a purchase from a brick and mortar store, a user, using his or her computing device (e.g., a smartphone or other mobile device), may have the ability to create, or initiate a creation of, a poll related to items selected by the user for purchasing decision. The poll may contain poll content, such as information about selected items, questions about poll recipients' preferences, optional responses provided by the user and selectable by the poll recipients, and other relevant information related to the purchase being considered by the user.

The user may also select a group of poll recipients (advisors), according to the user's preferences. The poll recipients may be associated with the user in some way (e.g., may be user's friends, colleagues, community members, and the like). For domain specific retailers, the poll creator may solicit the input of advisors with specific domain expertise. The poll recipients may be external to the retail entity providing the items for purchase, e.g., they may not necessarily be affiliated with the retail entity in any meaningful way. For example, the poll recipients may or may not be customers of the retail entity.

Once the poll has been created, the user may have the ability to provide the poll to the computing devices associated with selected poll recipients, e.g., via the user's online social networks, email, Short Message System (SMS) or text messages, or other communication means. The poll recipients may submit responses to the poll via their respective computing devices. The poll responses may be aggregated and reported back to the user's computing device to aid the user in the purchasing decision. Accordingly, users may be provided with a direct way to consult with trusted advisors to make an informed purchasing decision.

The poll responses may be provided to a third party, such the retail entity, to enable the retail entity to target the poll recipients according to their preferences that may be identified via the poll results. The poll responses may be provided to the poll recipients, in some embodiments with additional information about the products or services offered by the retail entity, based on the identified preferences of the poll recipients.

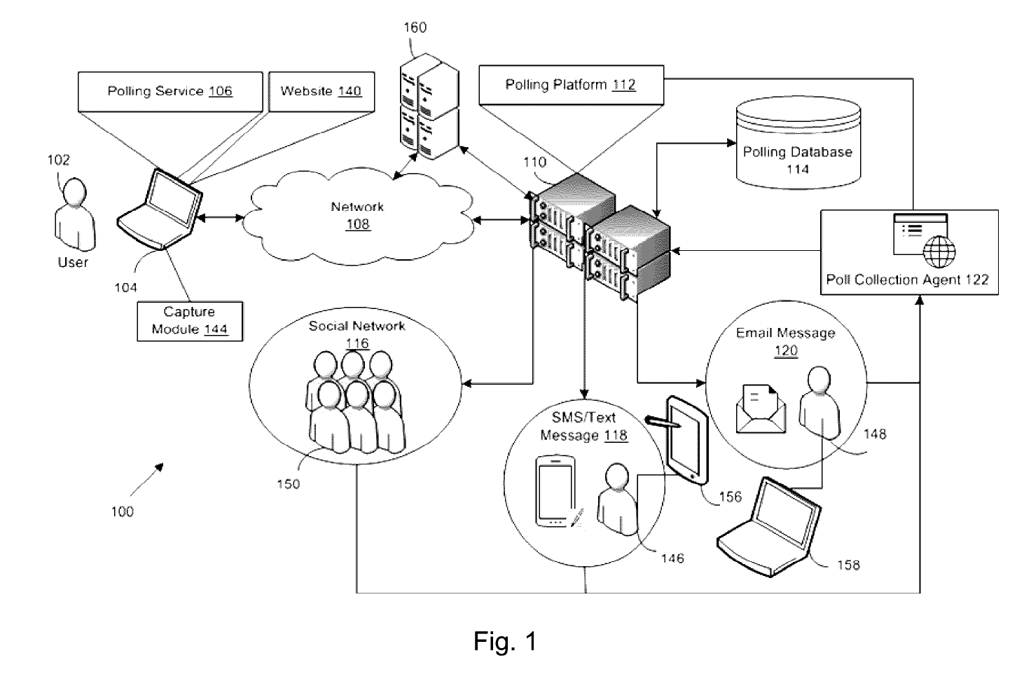

FIG. 1 is an example schematic representation of a polling system, in accordance with various embodiments of the present disclosure. In embodiments, polling system 100 may include a user's computing device 104 configured to enable user 102 to browse through products and/or services offered by any number of retail entities. For example, the user 102 may browse an online retail establishment, e.g., a website 140 rendered by a retail entity via the retail entity's server 160 on a user's computing device 104. The website 140 may be an electronic-commerce (e-commerce) website offering items (products and/or services), which user 102 may consider for purchasing. In another example, the user 102 may browse a brick and mortar store of the retail entity for products and/or services.

The computing device 104 may include a polling service 106 disposed thereon (or served from polling platform 112 or website 140) and configured to enable user 102 to select one or more items (products or services) for purchase consideration. For example, the user 102 may select the items for purchase consideration from an e-commerce website or a brick and mortar establishment.

To enable item selection, the computing device 104 (e.g., polling service 106) may be configured with (or served from e.g., polling platform 112 or website 140) a capture module 144. It should be noted that the computing device 104 may take the form of any computing device including any mobile or stationary computing device incorporated with networking capability. For example, in some embodiments, the polling service 106 may be disposed on a smartphone (or served to the smartphone from polling platform 112 or website 140). In such embodiments, user 102 may be able to utilize the polling service 106 and associated capture module 144 in a conventional brick and mortar retail setting. To select items in a brick and mortar establishment, the capture module 144 may comprise a capture device such as a camera, a barcode (or Quick Response Code (QR)) scanner and the like, for taking an image of the item, selecting a uniform resource locator (URL) associated with the item, scanning the barcode associated with the item, or any other suitable device capable of identifying the products and/or services, which the user 102 may consider for purchasing.

As an example, user 102 may be contemplating buying a shirt in a retail brick and mortar store. In such a scenario, the captured images may be not only of the individual products, but of the user wearing the individual products. In additional embodiments, polling service 106 may be configured to utilize the camera to capture a barcode of a product and to utilize the barcode in gathering information on the product for submitting a poll.

To enable item selection in an online establishment, e.g., website 140, the polling service 106 may be integrated with the website 140. For example, the capture module 144 may be enabled to capture and process item selection on the website 140 by the user 102. In some embodiments, the polling service 106 may be an independent web application, an application extension (e.g., a browser plug-in), or a fully functional executable application. In any of these embodiments, the polling service 106 may be configured to enable user 102 to select one or more items from the website 140, e.g., using associated capture module 144.

The polling service 106 may be further configured to create and submit a poll to a group of selected recipients (e.g., selected from the user's contact list on computing device 104, or a group of associates/friends in a social networking site), soliciting feedback concerning the selected items, which user 102 may be considering purchasing. A poll may include text, audio, image, video, or a combination thereof. In some embodiments, the poll may be generated by the user 102. In some embodiments, the poll may be generated by the retail entity (e.g., at server 160) or by a polling platform 112 residing at a polling server 110, on behalf of the user 102, based on the user history data accumulated by the retail entity. Such history data may include, for example, information about what the user 102 has viewed throughout the time spent at the online retail store (e.g., during a current session and/or previous sessions) and/or based on prior browsing history.

The polls may be generated on the individual item page, online shopping cart, or throughout the time spent by the user 102 on the retail entity's website 140 or brick and mortar establishment. Poll content (e.g., questions to recipients) may be standardized, for example: “which shirt should I buy?” In some embodiments, the poll content may be customized based on the user 102 preferences. The generated poll may be communicated (e.g., emailed) to the computing device 104 of the user 102 with a call-to-action to send it to the user 102's friends, followers, or the external online community, to help the user 102 make a purchase decision.

In some embodiments, the polling service 106 may submit the poll to the polling platform 112 associated with the polling server 110, via network (e.g., Internet or other suitable network or networks) 108. The polling platform 112 may configure polling server 110 to receive the poll and distribute the poll to a group of selected recipients 146, 148.

In some embodiments, the polling service 106 may submit a request to create a poll to the polling platform 112. The polling platform 112 may create a poll (e.g., a poll shell) and provide the poll to the user for review. In other embodiments, the polling platform 112 may distribute the poll to the selected poll recipients 146, 148.

The poll recipients 146, 148 may be selected manually from a group of possible recipients 150 by user 102 via the polling service 106. In some embodiments, the poll recipients 146, 148 may be automatically selected from possible recipients 150 by the polling platform 112 (e.g., selected from the user's contact list on computing device 104, a group of associates/friends in a social networking site, a curated group of known domain experts, or the general public).

The polling platform 112 may distribute the poll to the selected poll recipients 146, 148, by delivering the poll to the recipients' respective computing devices 156, 158. The poll may be distributed through a delivery mechanism associated with the individual recipients. Such delivery mechanisms may include social network 116, SMS or text message 118, email message 120, mobile push notifications, a window/view inside a mobile polling application or other communication means known in the art. In some embodiments, the delivery mechanism may be retrieved from a polling database 114.

In general, the poll may be distributed to recipients via a range of networks (social, email, text, mobile push notifications etc.). As described above, the poll recipients may be associated with the user: they may be the user's “friends’ on Facebook®, relatives, colleagues, and the like. The recipients may not necessarily, or not at all, be associated with the retail entity providing the items for purchase selected by the user. In other words, the recipients may be external to the retail entity.

In some embodiments, the poll may be contained within the communications distributed to the recipients 146, 148 via their computing devices 156, 158. For example, a recipient may be able to respond to the poll via the recipient's social network with answers to the questions. In some embodiments, the individual communications may contain a link to a poll collection agent 122, such as, for example, a website associated with the poll, which the recipient may then use to navigate to the poll collection agent to complete the poll. In some embodiments, the website may facilitate opening of a mobile client application where the recipient will place their vote and interact with the polling agent via a web-based Application Programming Interface (API).

The poll responses (poll results) may be collated across the networks and provided to the polling platform 112. The poll results may then be parsed by the polling platform 112 for aggregation and analysis, e.g., for identifying the recipients' preferences associated with the selected items. The polling platform 112 may provide the aggregated poll results to the user 102's computing device 104 to aid user 102 in making a purchasing determination. In some embodiments, polling platform 112 may provide the aggregated poll results to the poll recipients 146, 148 via recipients' respective computing devices 156, 158. Further, the polling platform 112 may provide the aggregated poll results with poll recipients' preferences to the retail entity (e.g., via retail entity server 160), for further targeting the poll recipients.

The poll creation, poll distribution, selection of poll recipients, and provision of poll results are discussed in further detail below.

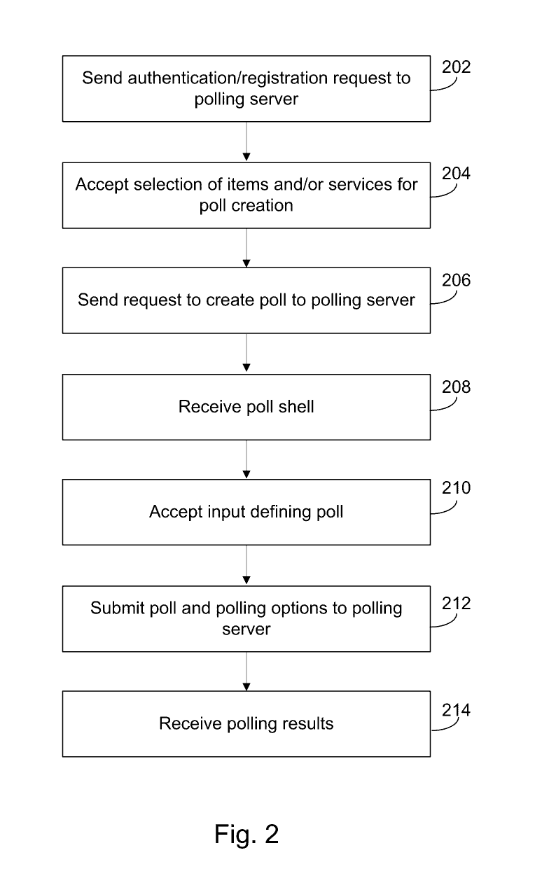

FIG. 2 is an example process flow of the polling service of the polling system of FIG. 1 (e.g., polling service 106 of FIG. 1), in accordance with various embodiments of the present disclosure.

The process may begin at block 202, where a polling service may send an authentication request to a polling platform (e.g., polling platform 112 of FIG. 1). Such a request may include any customary authentication information, such as, for example, a username and password combination, biometric information, cookie verification, or any other suitable information to authenticate the user.

Prior to or concurrently with sending an authentication request, a registration request may be submitted by the polling service to the polling platform. For example, a user (e.g., user 102 of FIG. 1) may be prompted by the polling service to create an account and may be taken through a registration process (not depicted) by the polling service where the user may register a polling account. This registration process may include entry of information associated with the user, such as, for example, the user's mailing address; physical address; electronic-mail (email) address; telephone number; identification of one or more social networks that may include poll recipients (advisors) to whom a poll may be submitted for completion; identification of one or more advisors and a manner of contacting the individual advisors of the one or more advisors (e.g., an email address, phone number, or social network to utilize in contacting the individual advisor). This information may be stored in a repository (e.g., polling database 114). Alternatively, a user may be able to authenticate using 3^{rd} party authentication providers (Twitter®, Facebook®, Microsoft®, Google®, etc.) who supply an authentication mechanism (e.g., OAuth®) and an authentication token to the polling platform enabling the user to bypass a polling service registration.

In embodiments, the polling service may be integrated directly with a number of social networks for identification of the individual social networks that may include advisors to whom to submit a poll. For example, the user may select any number of individual social networks and authenticate to the individual social networks via any authentication mechanism (e.g., OAuth®) to allow polling service access to social networks identified by the user.

In some embodiments, the authentication mechanism may send an authentication token to the polling service to be utilized by the polling service to interact directly with the individual social networks. The polling service may manage individual tokens respectively associated with the individual social networks identified by the user for access to the each of the social networks. For example, the user may identify Facebook® as one of the social networks and the user may then authenticate to Facebook®. In return, Facebook® may send a token in response to the authentication, to be utilized by polling service to interact directly with the user's Facebook® account. This token may be managed along with tokens for other social network accounts of the user to enable polling service access to each of the social networks identified by the user. Examples of such social networks may include, but are not limited to, Facebook®, Google+®, LinkedIn®, Twitter®, Pinterest®, Tumblr®, Myspace®, Flickr®, Instagram®, etc.

At block 204, the polling service may enable the user to select products and/or services for purchasing consideration. This may be accomplished, for example, by enabling the user to select the products and/or services from an e-commerce website, select a uniform resource locator (URL) associated with the products and/or services, scan a barcode associated with the products and/or services, or use any other suitable form of identifying the products and/or services, which the user may select for purchasing consideration and for which the user may want to submit a poll. For example, the user may select the items and place the selected items in an online shopping cart associated with the online retail entity.

At block 206, the polling service may send a request to the polling platform to create a poll for the selected products and/or services. The request may include information about the selected items or services, such as to identify the items or services selected by the user.

At block 208, the polling service may receive a poll shell from the polling platform in response to the request provided at block 206. In embodiments, the poll shell may be configured for the selected products and/or services. For example, if the user selected a coat, the poll shell may include an image of the coat, any available colors, selectable predefined questions, such as whether the coat is waterproof and/or how well the waterproofing works, etc. In addition, the poll shell may include an area for the user to define custom questions and selectable options associated with those questions to submit with the poll along with the ability for the user to designate a group of poll recipients (advisors) to whom the poll may be distributed.

At block 210, the polling service may accept input from the user defining the poll. Such input may include the selection of poll questions from the poll shell, definition of custom questions, and/or selection of poll recipients, including the option to broadcast the poll anonymously to the general public. In some embodiments, such input may also include a time period for which to keep the poll open and/or a minimum or maximum number of responses after which to close the poll. The time period may be a specific duration (e.g., 24 hours) or a specific time and date on which the poll will expire. The minimum or maximum number of responses may be defined by a specific number or a percentage in addition to, or in place of, the time period. For example, the user may wish to close the poll after a determined time period (e.g., 24 hours) or once the number of responses reaches a determined number (e.g., 50%) of those polled, or after either of these events, whichever occurs first. The user may also specify if they want the poll results to be visible to recipients or not after a recipient casts their vote.

For example, the user may have viewed several items within an online retail entity. The poll may be generated based on the viewed items. The user may send the generated poll to selected recipients via his or her respective networks. The poll may include, for example images of the items and associated content. The associated content may include, for example, questions regarding the preferences of the poll recipients with regard to the viewed items.

In embodiments, selection of poll recipients, e.g., advisors to whom to submit the poll may be selected from a group of possible advisors. The group of possible advisors may be populated by a contact list local to polling service or remotely stored. For example, if the polling service is being utilized on a user's smartphone, the polling service may access the user's contact list on the smartphone to add the user's contacts to the group of possible poll recipients. In some embodiments, the group of possible poll recipients may also be populated by accessing the user's identified social network, (e.g., utilizing the token discussed above) and retrieving members of the user's identified social network to add to the group of possible advisors.

In addition, the group of possible advisors (poll recipients) may be organized based upon the resources that the possible advisors originated from. For instance, the group of possible advisors may have subgroups identified by, e.g., individual social networks, local contacts list, etc. from which the individual advisors were pulled and the user may select one or more of these subgroups to submit a poll to.

In some embodiments, the “most appropriate” poll recipients for a given retail poll may be identified. This may be done by analyzing history of poll responses, product/category associations, and respondent “success” rate. “Success” may be defined as the poll originator (user) acting on the respondent's recommendation, such as viewing or purchasing the product the respondent voted on. Machine learning algorithms may be used (e.g., exposed through APIs) to analyze each poll response, and make recommendations for “most appropriate” advisor for a given question, product, category, and/or success rate.

Accordingly, as discussed above, the poll recipients may be associated in some way with the user, but may be external to a retail entity providing items (products and/or services) for purchase by the user.

In some embodiments, the polling service may be configured to enable the user to designate categories of products and/or services to associate with individual advisors, which may be stored in the repository by the polling service during the registration process. In other embodiments, the polling platform may be configured to determine categories of products and/or services to associate with individual advisors through interests, hobbies, careers, etc., determined from information available through the user's and/or individual advisor's social networks. For example, one of the advisors may be an automotive mechanic and, as a result, the user may designate that polls concerning automotive products and/or service are sent to this advisor by default or the polling platform may be configured to determine such a designation from the user's social network.

At block 212, the polling service may submit the poll to the polling platform, which may carry out the actual polling of the advisors and aggregation of poll results. The poll recipients (advisors) may receive the poll through their respective communication means (e.g., networks) and vote on the poll either through the web voting experience or an application voting experience (if installed on their computing devices). The votes may be tallied on the back-end server (e.g., in real- or near-real time) and the results are presented to user 102 through the poll agent, for example, upon expiration of the poll.

In some embodiments, the actions described in reference to blocks 206, 208, 210, and 212 may be performed in a different fashion. For example, poll creation may be performed by the polling platform in response to the poll request described in reference to block 206. In other words, the user may create the poll through the polling service without the need of the poll shell described above. The user input described in reference to block 210 may be provided to the polling platform along with the poll request. The polling platform may create and distribute the poll to the poll recipients based on this information.

At block 214, the polling service may receive the aggregated results of the poll back from the polling server and may display the results to the user. The user may utilize the poll results in making a purchasing decision with respect to the selected products and/or services. In some embodiments, the polling results may include a link to an e-commerce website from which the products and/or services were selected, a listing of retail entities offering the products and/or services, products and/or services that complement the selected products and/or services (e.g., local kayaking lessons where a kayak is selected), along with any promotions associated with the above from individual retail entities (e.g., sales) or manufacturers (e.g., rebate). The results experience may also link directly back to an online shopping cart for an individual retailer with the product and/or services that were selected pre-populated in the cart.

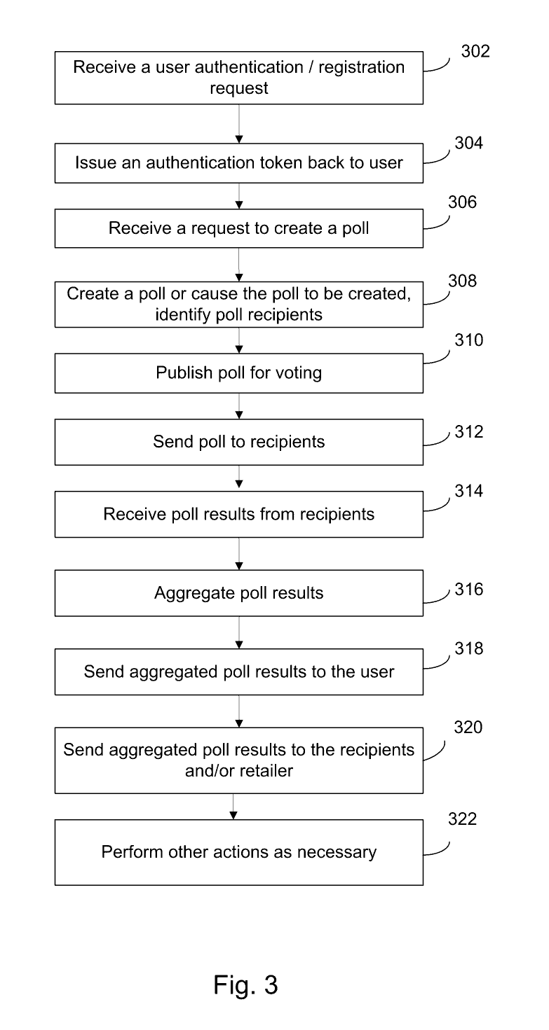

FIG. 3 is an example process flow of a polling platform provided by a polling server (e.g., polling platform 112 provided by the polling server 110 of FIG. 1), in accordance with various embodiments of the present disclosure.

The process may begin at block 302, where the polling platform may receive a user authentication request along with information to utilize in authenticating the user, sent by a polling service, e.g., polling service 106, as indicated by block 202 of FIG. 2. In some embodiments, the polling platform may receive a registration request (e.g., for a new user). The polling platform may then carry out portions of the registration process described above in reference to block 202 of FIG. 2.

At block 304, the polling platform may issue an authentication token generated by the polling platform in response to the authentication or registration of the user. This authentication token may enable the user to interact with the polling platform (e.g., via a polling service such as polling service 106 of FIG. 1), without the need to re-authenticate.

At block 306, the polling platform may receive a request create a poll. In some embodiments this request may include identification of products and/or services for which a poll shell is to be generated. In such embodiments, the polling platform may retrieve, e.g., from a polling database (e.g., database 114) or a storage facility associated with the retail entity, information, such as images of the identified products and/or questions associated with the identified products and/or services, or associated with a category to which the products and/or services belong, to create the poll shell described in reference to FIG. 2. In other embodiments, the poll may be defined by the user and submitted to the polling platform.

At block 308, the polling platform may create a poll in response to the request. The poll creation may include a creation of poll shell and provision of the poll shell to the user as discussed in reference to FIG. 2. In some embodiments, the polling platform may create a poll based on information associated with the poll creation request, such as information about items selected by the user for polling, as discussed in reference to FIG. 2. In some embodiments, the poll may be generated by the user, e.g., in response to a reception of the poll shell, and provided to the polling platform for publishing and submission to poll recipients. In some embodiments, the poll shell may be created by the polling service disposed on the user's computing device.

For example, a user may have selected item(s) to add to his or her online shopping cart. The user may be presented with the ability (e.g., poll shell) to generate a poll based on the items in the online shopping cart. The poll may be generated by the user based on the content of the online shopping cart or automatically created after a determined period of time from the time instance when the item or items were placed in the shopping cart (for example, 24 hours of an item being in the cart yet not purchased).

At block 310, the polling platform may publish the poll for voting. In such embodiments, the poll may be published as a website to which the recipients of the poll may have access (e.g., poll collection agent 122 of FIG. 1). The polling platform may send the final version of the poll to the user for review.

At block 312, the polling platform may send the poll to the recipients. In some embodiments, the polling platform may facilitate poll execution (e.g., distribution) by the user, by allowing the user to send the poll to his or her poll recipients via respective social networks or other communication means.

As discussed above, the poll recipients may be selected based upon the products and/or services for which the poll is generated or may be based upon selection of recipients from possible recipients by the user. In embodiments, where the recipients are selected based upon the products and/or services, the polling server may determine selected recipients from possible recipients based on categories of products and/or services associated with individual possible recipients. The categories may be associated with the individual possible recipients manually by the user or automatically by the polling platform utilizing information available from the user's social network.

The polling platform may send the poll to selected poll recipients via a social network, of which individual selected recipients may be members (e.g., utilizing the token discussed above in reference to FIG. 2), via SMS or text messaging, via email, mobile push notification, or through any other appropriate form of communication. In some embodiments, the poll may be contained within the individual communications. For example, the recipient may be able to respond to the text message with answers to the questions. The answers may then be parsed by the polling platform for aggregation and analysis, to identify the respondents' tastes, preferences, and the like. In embodiments where the poll is published as a website, the individual communications from the polling server may contain a link to the website which the recipient may then use to navigate to the website to complete the poll. In some embodiments, the recipients may need to individually authenticate via the website or associated mobile application prior to being able to complete the poll.

At block 314, the polling platform may receive the poll results from individual recipients, e.g., via different communication means discussed above.

At block 316, the polling platform may aggregate the poll results. For example, the polling platform may process and group or otherwise dispose in accordance with the user preferences, in order to provide a poll results view to the user as described below. For example, the poll results may be aggregated with poll results from other individual recipients. In some embodiments, responses from the individual recipients may be stored in a polling database (e.g., polling database 114 of FIG. 1) as sentiment data associated with respective individual recipients.

At block 318, the polling platform may send the aggregated poll results to the user. In some embodiments, the poll results may be sent to the user after the passage of a predefined period of time, at a specific date and time, or once the response rate reaches a predefined threshold defined by number of recipient responses or percentage of recipients to respond. In some embodiments, the polling platform may also retrieve products and/or services associated with the products and/or services for which the poll was submitted as well as any promotions applicable thereto.

At block 320, the polling platform may send the aggregated poll results and associated information, such as poll recipients' preference data, to the poll recipients and/or retail entity. The poll recipients' preference data may be released to the manufacturer, retail entity, and/or provider of the products and/or services for consideration in future business decisions. For example, the poll recipients' preference data may be utilized to determine additional information, such as possible promotions that may be communicated to the respective individual recipients. In another example, if the poll recipients' preference data concerns a coat, and reflects that the overall satisfaction with the coat was good until a seam of the coat failed, then the manufacturer may take this information into account when deciding on a seam or production facility to use in the future, or a retail entity may take this information into account when deciding what products to offer.

In another example, poll recipients may be further targeted based on results of their poll submissions. For example, if the poll provided to the poll recipients concerns a set of shoes to choose from, the poll results may contain information about the recipients' preferences on shoes, by virtue of recipients' participating in the poll and thus identifying their preferences. In some embodiments, the polling platform may be configured to analyze the poll results to identify the recipients' preferences, tastes, opinions, rankings, reviews, and the like, based on the poll results. Accordingly, the polling platform may act on behalf of the retail entity, in order to provide information for targeting the recipients based at least in part on their identified preferences, tastes, opinions, and the like.

Based on the recipients' preferences, the retail entity may be able to target the recipients with information about the shoes of their preferences and related items (e.g., accessories) and other related information, e.g., advertisements, promotions, and the like. For example, a client-side cookie may be provided to the recipients' computing devices to allow the polling service or associated retail entity to retarget the recipients.

In some embodiments, the polling platform may provide to individual poll recipients, in conjunction with the poll results or separately, target information on behalf of the retail entity. The target information may be based on the identified preferences, opinions, and the like, of the poll recipients that may be gathered from the poll results. For example, the polling platform may provide to the poll recipients some advertisements, retail promotions, rebates, information about items related to one chosen by the recipient (e.g., related item descriptions), and the like.

In another example, an individual recipient may include in his or her poll response that he or she trusts a particular brand associated with the retail entity. Accordingly, the polling platform may retrieve information related to the identified brand from the retail entity and provide the retrieved information to the poll recipient.

At block 322, the polling platform may perform other actions as necessary. For example, the user may select multiple items from the online retail store, for which poll results may be received by the polling platform at block 312. The user may select, e.g., prior to the poll, a purchase option that may specify that the item that generates the most votes in an associated poll may be purchased for the user based on the poll results. Accordingly, upon poll completion the item may be automatically purchased for the user from the associated retail entity.

As described above, the individual poll recipients may have access to the aggregated poll results and/or a purchasing determination made by the user. The user may select whether the aggregated poll results and/or the purchasing determination are so accessible via a polling service (e.g., polling service 106 of FIG. 1) at the time of defining the poll, at the time of receiving the aggregated results, or at the time of making the purchasing determination.

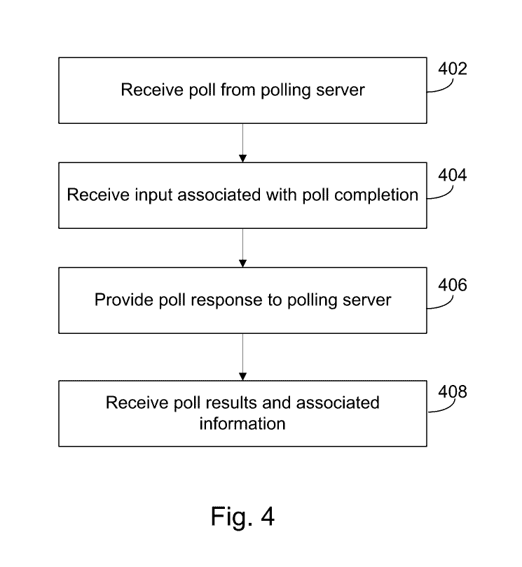

FIG. 4 is an example process flow of a poll completion procedure that may be performed by a computing device associated with a poll recipient, in accordance with various embodiments.

The process may begin at block 402, where a poll may be received by the computing device that may be sent by a polling server, such as polling server 110 of FIG. 1, as indicated by block 312 of FIG. 3. In embodiments, the poll may be received via a communication sent to a poll recipient through a social network to which the recipient belongs, via an SMS or text message sent to a mobile device associated with the recipient, email sent to an email address associated with the poll recipient, or other communication means. The communication may contain the poll itself, such that the poll recipient is able to complete the poll from the communication (e.g., by responding to the communication). In some embodiments, the communication may contain a link to be utilized by the poll recipient to navigate to a poll collection agent (e.g., poll collection agent 122 of FIG. 1) on the computing device. The poll may contain one or more questions to which a response is requested concerning products and/or services that a user is considering purchasing.

At block 404, the computing device may receive input from the recipient containing poll responses, and accept responses to the poll from the recipient.

At block 406, the computing device may provide the completed poll to the polling server, to be aggregated with responses from other poll recipients to aid the user in making a purchasing decision.

At block 408, the computing device may receive a communication via any of the above discussed mechanisms (e.g., social network, SMS/text message, email, mobile push notification, or the poll collection agent) containing aggregated poll results, a purchasing determination made by the user, and/or retail promotions based on the recipient's responses to the poll.

The following example may illustrate an application of embodiments described herein. Assume a user may be searching various retail sites, browsing merchandise. As the user is searching, detailed information about the items the user is viewing may be cached by a script running on the retailer's website locally on the user's machine using web browser cookies or other local storage system. Assume the user is searching for a pair of shoes. As the user continues to search items, the retail entity may store what products (e.g., shows) the user is exploring and details of where the user is in the view-purchase process. When the user leaves the retailer site without completing a transaction, the retailer site may (from a background server-side process in the retailer's own environment) call the polling service API to request a poll shell to be created on the user's behalf for the item(s) explored for later use by the user.

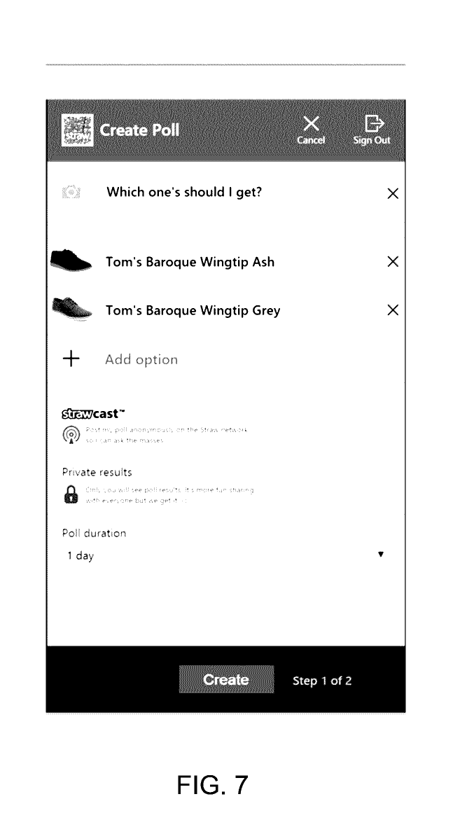

As the user browses other websites (third parties' websites) on the Internet, he or she may be presented (e.g., via a digital display advertisement network that supports ad retargeting and can read the retailer's data from the user's local cache) a summary (e.g., an image summary) of the poll shell that was generated on the polling platform after being notified by the retail site of the non-transactional customer. The user may be presented with the option to run a poll. The user may interact with the presented poll shell information. For example, the user may select the advertisement or other window, icon, or interface provided by the polling platform with poll shell information. The user may be redirected to the polling service web interface (an example view of which is presented in FIG. 7), where they will be authenticated, and the poll may be customized further, e.g., to customize recipients and other poll parameters (broadcast, distribution of poll results (if any), poll duration, auto purchase option, and the like).

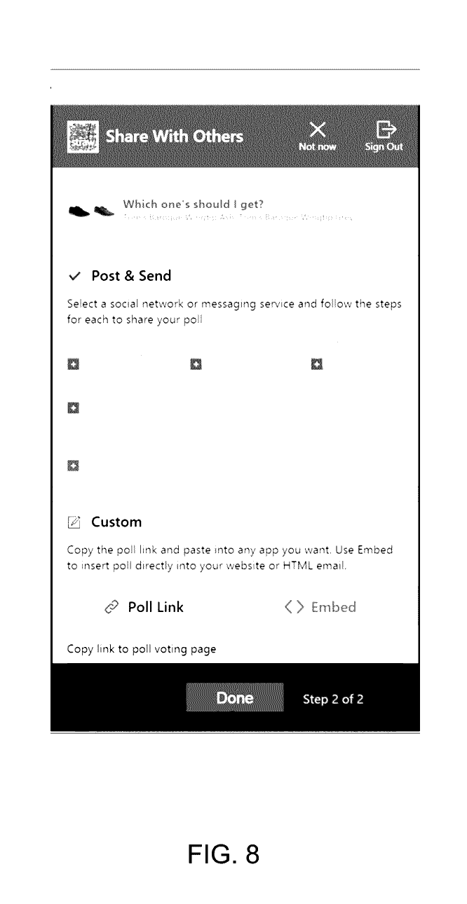

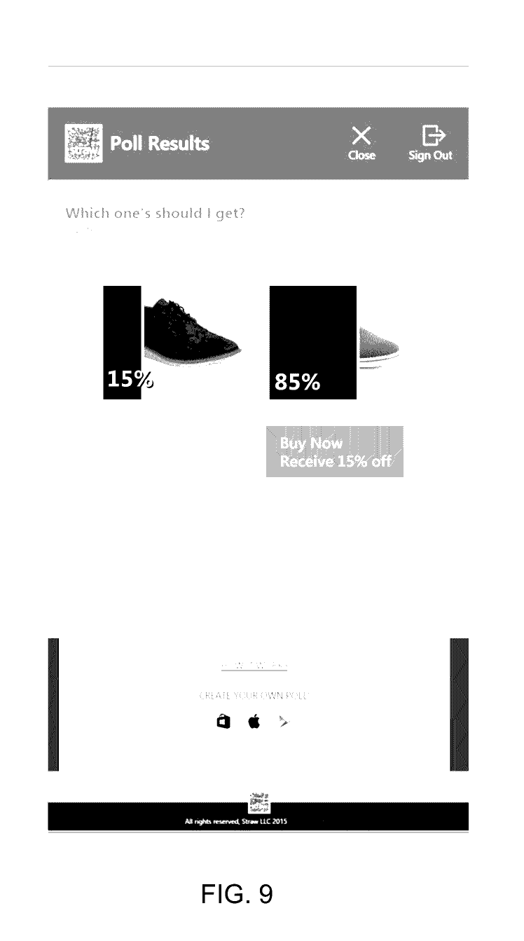

Accordingly, the user may finalize the poll and select the method of distribution, such as select existing social networks or other traditional methods (i.e. text/SMS message, email), and distribute the poll, as shown in the example view of FIG. 8. As the poll voters vote on the poll, the retailer may store information in the voters local machine using browser cookies or other local storage system that ties the individual to their vote (and by extension product preference). The voter may be retargeted by the same retailer via online digital ad networks across other 3^{rd} party sites with discount offers and other promotional materials, e.g., “Buy now, receive 15% off” as shown in FIG. 9, or even an ad that enables the retargeted voter to create and send their own poll. Similarly, after the end of the poll, the poll creator (user) may be presented with a promotional offer or discount (see FIG. 9).

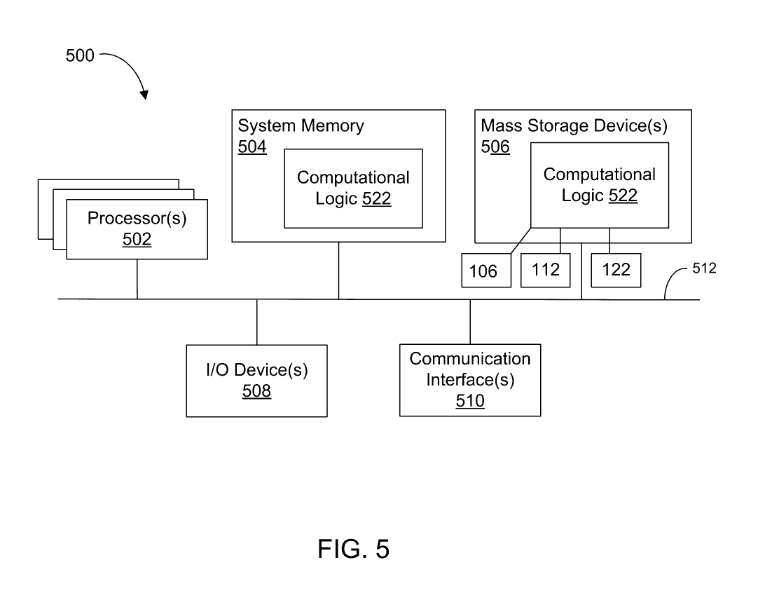

FIG. 5 is an example computing device suitable for implementing the embodiments of the present disclosure, in accordance with various embodiments. As shown, computing device 500 may include one or more processors or processor cores 502, and system memory 504. In embodiments, multiple processor cores 502 may be disposed on one die. For the purpose of this application, including the claims, the terms “processor” and “processor cores” may be considered synonymous, unless the context clearly requires otherwise. Additionally, computing device 500 may include mass storage device(s) 506 (such as diskette, hard drive, compact disc read only memory (CD-ROM) and so forth), input/output device(s) 508 (such as display, keyboard, cursor control and so forth) and communication interfaces 510 (such as network interface cards, modems and so forth). In embodiments, a display unit may be touch screen sensitive and may include a display screen, one or more processors, storage medium, and communication elements, and further it may be removably docked or undocked from a base platform having the keyboard. The elements may be coupled to each other via system bus 512, which may represent one or more buses. In the case of multiple buses, they may be bridged by one or more bus bridges (not shown).

Each of these elements may perform its conventional functions known in the art. In particular, system memory 504 and mass storage device(s) 506 may be employed to store a working copy and a permanent copy of programming instructions implementing the operations described earlier, e.g., but not limited to, operations associated with components of the polling system described herein, such as polling service 106, polling platform 112, or polling collection agent 122 of FIG. 1, generally referred to as computational logic 522. The various operations may be implemented by assembler instructions supported by processor(s) 502 or high-level languages, such as, for example, C, that may be compiled into such instructions.

The permanent copy of the programming instructions may be placed into permanent mass storage device(s) 506 in the factory, or in the field, through, for example, a distribution medium (not shown), such as a compact disc (CD), or through communication interface 510 (from a distribution server (not shown)). That is, one or more distribution media having an implementation of any of the components of the polling system described herein may be employed to distribute the components of the polling system and program various computing devices.

The number, capability and/or capacity of these elements 510-512 may vary, depending on the intended use of example computer 500, e.g., whether example computer 500 is a smartphone, tablet, ultrabook, laptop, desktop, server, etc. The constitutions of these elements 510-512 are otherwise known, and accordingly will not be further described.

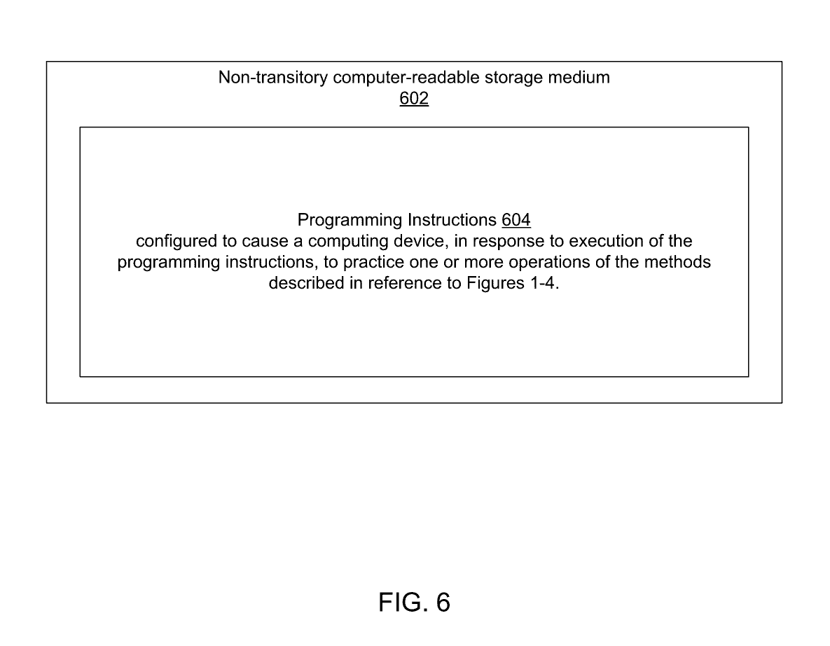

FIG. 6 is an example non-transitory computer-readable storage medium having instructions configured to practice all or selected ones of the operations associated with components of the polling system, earlier described, in accordance with various embodiments. As illustrated, non-transitory computer-readable storage medium 602 may include a number of programming instructions 604. Programming instructions 604 may be configured to enable a device, e.g., computing device 500, in response to execution of the programming instructions, to perform one or more operations of the processes described in reference to FIGS. 1-4. In alternate embodiments, programming instructions 604 may be disposed on multiple non-transitory computer-readable storage media 602 instead. In still other embodiments, programming instructions 604 may be encoded in transitory computer readable signals.

Referring back to FIG. 5, for one embodiment, at least one of processors 602 may be packaged together with computational logic 522 (in lieu of storing in memory 504 and/or mass storage 505) configured to perform one or more operations of the processes described with reference to FIGS. 1-4. For one embodiment, at least one of processors 502 may be packaged together with computational logic 522 configured to practice aspects of the methods described in reference to FIGS. 1-4 to form a System in Package (SiP). For one embodiment, at least one of processors 502 may be integrated on the same die with computational logic 522 configured to perform one or more operations of the processes described in reference to FIGS. 1-4. For one embodiment, at least one of processors 502 may be packaged together with computational logic 522 configured to perform one or more operations of the process described in reference to FIGS. 1-4 to form a System on Chip (SoC). Such a SoC may be utilized in any suitable computing device.

For the purposes of this description, a computer-usable or computer-readable medium can be any apparatus that can contain, store, communicate, propagate, or transport the program for use by or in connection with an instruction execution system, apparatus, or device. The medium can be an electronic, magnetic, optical, electromagnetic, infrared, or semiconductor system (or apparatus or device) or a propagation medium. Examples of a computer-readable media include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and DVD.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

What is claimed is:

1. An apparatus for providing a poll service, comprising:
a processor;
a capture module operated by the processor to capture a selection of one or more items from a plurality of items provided by a retail entity; and
a poll service module coupled with the capture module and operated by the processor to:
initiate a creation of a poll regarding a purchase of at least one of the selected one or more items, based on the selection of one or more items; and
perform or cause to perform a distribution of the poll to a plurality of poll recipients that are external to the retail entity.

2. The apparatus of claim 1, wherein the poll service module is operated by the processor to receive and render for display poll results provided by at least some of the poll recipients in response to the distribution of the poll.

3. The apparatus of claim 1, wherein the poll service module is operated by the processor to authenticate with a poll platform that facilitates poll creation and distribution.

4. The apparatus of claim 3, wherein the poll service module is operated by the processor to receive a poll shell from the poll platform, wherein the poll service module is to initiate a creation of a poll based in part on the poll shell.

5. The apparatus of claim 1, wherein the capture module comprises a capture device, wherein the capture device is selected from one of: a camera, a bar-code scanner, or Quick Response Code (QR code) scanner.

6. The apparatus of claim 1, wherein the capture module comprises a capture component integrated with a retail website provided by the retail entity, to capture and process item selection on the retail website.

7. An apparatus for facilitating a poll service, comprising:
a processor;
a polling platform module operated by the processor to:
facilitate a poll creation and distribution to a plurality of poll recipients, based on a selection, by a user at a retail entity, of one or more items from a plurality of items provided by the retail entity; and
provide poll results, submitted by at least some of the plurality of poll recipients in response to the poll distribution, to the retail entity, to facilitate targeting of the poll recipients by the retail entity, wherein the poll recipients are external to the retail entity.

8. The apparatus of claim 7, wherein the polling platform module is operated by the processor to receive a request, from the user, to create the poll or facilitate the poll creation, wherein the request includes the selection of the one or more items.

9. The apparatus of claim 7, wherein the polling platform module is operated by the processor to receive the poll results, before provision of the poll results to the retail entity.

10. The apparatus of claim 7, wherein the polling platform module is operated by the processor to identify the poll recipients that are external to the retail entity.

11. The apparatus of claim 10, wherein the polling platform module is operated by the processor to identify the poll recipients based on poll recipient information provided by the user.

12. The apparatus of claim 7, wherein the polling platform module is operated by the processor to submit the poll results to the user, to facilitate a decision to purchase one of the one or more items.

13. The apparatus of claim 7, wherein the polling platform module is operated by the processor to aggregate the poll results, wherein to aggregate includes to analyze the poll results to identify preferences of the poll recipients.

14. The apparatus of claim 13, wherein the polling platform module is operated by the processor to provide content associated with the retail entity to the poll recipients, on behalf of the retail entity, based at least in part on the identified preferences of the poll recipients.

15. The apparatus of claim 14, wherein the content provided to the poll recipients includes one of: advertisements, promotions, rebates or item descriptions accessible by the polling platform module.

16. The apparatus of claim 13, wherein the polling platform module is operated by the processor to facilitate a purchase of an item of the plurality of items, based at least in part on a result of the analysis of the poll results.

17. One or more non-transitory computing device-readable media having instructions for facilitating a poll stored thereon that, in response to execution on a computing device, cause the computing device to:
facilitate a poll creation and distribution to a plurality of poll recipients, based on a selection, by a user at a retail entity, of one or more items from a plurality of items provided by the retail entity; and
provide poll results, submitted by at least some of the plurality of poll recipients in response to the poll distribution, to the retail entity, to facilitate targeting of the poll recipients by the retail entity, wherein the poll recipients are external to the retail entity.

18. The non-transitory computing device-readable media of claim 17, wherein the instructions further cause the computing device to identify the poll recipients that are external to the retail entity.

19. The non-transitory computing device-readable media of claim 17, wherein the instructions further cause the computing device to analyze the poll results to identify preferences of the poll recipients.

20. The non-transitory computing device-readable media of claim 19, wherein the instructions further cause the computing device to provide content associated with the retail entity to the poll recipients, on behalf of the retail entity, wherein the provided content is based at least in part on the identified preferences.
